(19) United States
(12) Patent Application Publication
(10) Pub. No.: US 2023/0069116 A1
(43) Pub. Date: Mar. 2, 2023

(54) PLATFORM SCREEN DOOR

(71) Applicant: KNORR-BREMSE RAIL SYSTEM (UK) LTD, Melksham, Wiltshire (GB)

(72) Inventor: Peter Bailey, Melksham, Wiltshire (GB)

(21) Appl. No.: 17/794,466

(22) PCT Filed: Jan. 22, 2021
(86) PCT No.: PCT/EP2021/051529

§ 371 Date: Jul. 21, 2022

(30) Foreign Application Priority Data
Jan. 22, 2020 (GB) 2000913.0

(51) Int. Cl. E05D 15/06; B61B 1/02

(52) U.S. Cl. CPC E05D 15/063; B61B 1/02; E05Y 2201/684

(57) ABSTRACT

A platform screen door system having a fixed panel and a door panel, wherein the system is provided with a track (11) having a convex surface adapted to support a roller (14), which roller is rotatably mounted on the moving panel and has a concave surface and has two points of contact (17) on the track.

The invention relates to a platform screen door system and in particular to the drive system for a platform screen door system.

The conventional railway station consisting of a raised platform adjacent to the track is essentially the same design as has been used since the beginning of the railway industry in the nineteenth century and is an effective solution to the problem of maximising passenger boarding speed.

However, the basic platform arrangement suffers from several well-known problems, such as passengers falling under trains either deliberately or unintentionally and also litter from passengers falling onto the track. Although incidents of people falling under trains are not common, they result in significant disruption to the network and are traumatic incidents for everyone present. The problem of litter on the track has also increased in recent years and can represent a serious health and safety risk on underground or sub-surface systems where the litter will remain in tunnels until it is cleared up.

Platform screen door systems or automated platform gates are well known in the railway industry as one approach of dealing with these problems. Due to the problem of lining up doors on the platform and the train, these systems are usually only installed on lines where the rolling stock is standardised, which in practice is on metro or underground systems, although some dedicated high-speed systems are also provided with screens.

The design used for the support system for the sliding doors for many years on numerous projects was to form a metal track from Stainless Steel in the form of a “J” and have “nylon” (as a generic term) rollers running inside it. The top of the track is extended over the top of the roller to prevent the door from being lifted out of the track. The door weight is fully supported on these rollers at the top as the bottom of the sliding door only has a guide track to keep the door running in line. Alternative approaches such as those disclosed in CN209855503 and JP2020011673 have not been implemented on a commercial scale and seem liable to suffer from the door being lifted from the track.

One of the maintenance issues with Platform screen doors is the effect of wear on the operation of the system and the need to regularly replace rollers. Worn rollers lead to friction, sticking and jumping of the system, notchy operation and service affecting trip outs. Despite the inherent advantages, the relatively high capital and maintenance costs of platform screen door systems has resulted in a slow uptake of the systems.

The present invention therefore seeks to provide a platform screen door system that is simpler to produce, is more reliable, cheaper and simpler to maintain and has a longer operational life.

According to the invention there is provided a platform screen door system having a fixed panel and a moving door panel, wherein the system is provided with a track having a convex surface adapted to support a roller, which roller is mounted on the moving panel, which roller has a concave surface.

On the original J-track design, the roller and track profiles are designed so that the very outer diameter of the roller is the only part in contact with the track, but as the number of operations increases so does the wear until the point that the roller and track profiles are matched. This would result in two different diameter surfaces of the roller being in contact with the track at the same time, resulting in the roller scuffing along the track increasing the wear rate even more. This leads to the door juddering and chattering as it moves creating a noise and service affecting failures in known designs. The solution of the invention with a convex track and concave roller surface advantageously avoids this wear resulting in longer maintenance intervals and lower maintenance costs.

In a preferred embodiment in which the track is extruded, the solution advantageously avoids the bending/forming process could leave score/drag lines in the track surface adjacent to the direction of roller travel, which is a possible reason for increased wear rate of the roller during operation. Further preferred aspects of the invention can be found in the sub-claims.

An exemplary embodiment of the invention will now be described in greater detail with reference to the drawings, in which:

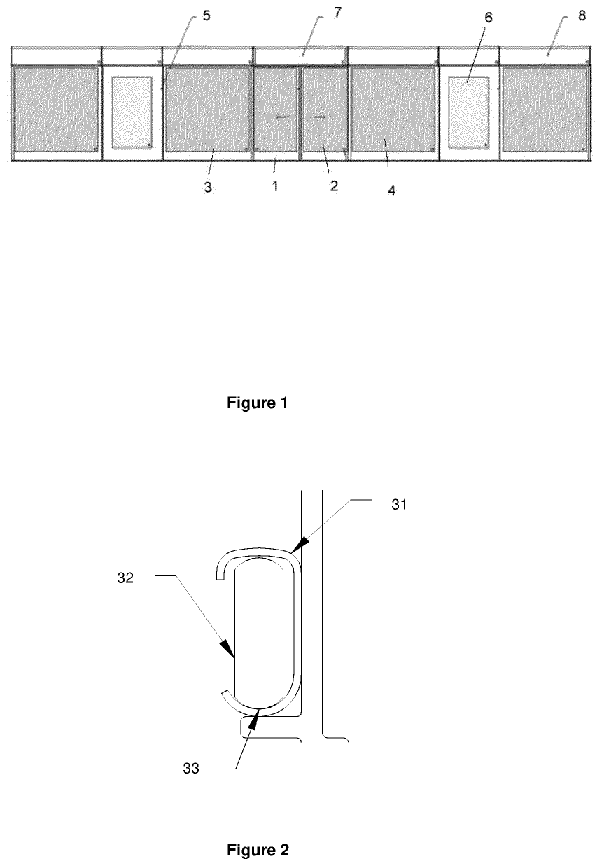

FIG. 1 shows a platform screen door system;

FIG. 2 shows a typical J-track design and

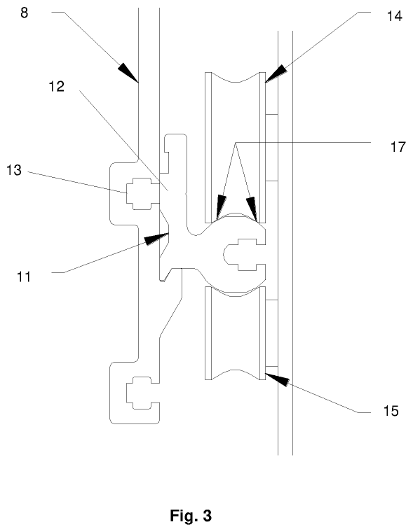

FIG. 3 shows the new concave roller design.

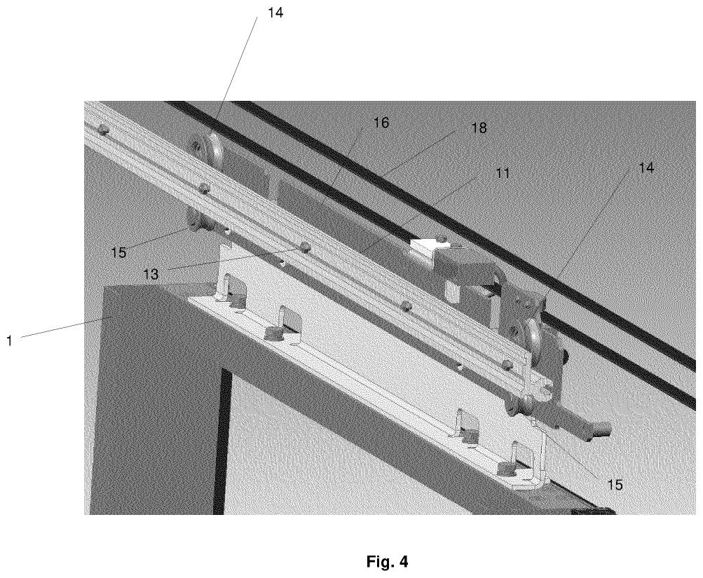

FIG. 4 shows a perspective view of the door support mechanism

FIG. 1 shows a platform screen door system with the sliding doors in the closed position on a railway platform comprising a first pair of sliding door leaves 1, 2, adjacent to a respective fixed panel 3,4. A media panel 5, 6 is provided adjacent to the fixed driving panel 3,4. A display panel 7 is located above the door leaves 1,2. A header structure 8 is located above and behind the fixed panels and sliding doors to enclose the drive mechanism to open and close the doors.

FIG. 2 shows a cross section of the known arrangement of a drive mechanism, in which the door is driven on rollers 32 having a convex profile in a matching J track 31. The roller has a single point of contact 33. Because of the weight of the sliding doors which can be as high as 95 Kg, the J-track is manufactured from 2.5 mm thick material to a precise profile. The known designs suffer from a number of problems, in particular the precise profile required has proved difficult to produce consistently at an acceptable cost. Wear on the rollers also results in the accumulation of dust and debris in the track, which in turn leads to greater wear of the rollers. Replacement of the rollers is difficult during routine maintenance and so the wear may lead to operational problems.

FIG. 3 shows a partial end view through a fixed panel or header structure and a door leaf. Shown here are the header structure 8 on which a track 11 is mounted. The track comprises a flange 12 which provides the bolted connections 13 for mounting the track on the header structure 8. The track 11 is convex and has a C shaped profile in cross section with the open part of the C facing away from the header structure. The main roller 14, which has an inverted structure, is rotatably mounted on the sliding door and in the installed position shown here sits on the upper surface of the track 11. The roller 14 has a concave cross-section in the plane parallel to the rotational mounting. The angle of curvature of the concave section is such that the roller has two points of contact 17 with the surface of the rail 11. The points of contact are located adjacent to the circular face of the roller 14, the outer diameter of the roller. The sliding door is provided with a secondary roller 15 located, rotationally mounted, below the lower surface of the rail 11. The secondary roller 15 is located with a small clearance below the rail so that in use the secondary roller 15 does not touch the rail 11 but will prevent the door being lifted off of the rail 11 in use.

FIG. 4 shows a perspective view of a part of the platform screen door system with the door leaf 1 visible. The rail 11 is shown apart from the rest of the header structure. Main rollers 14 are attached to either end of a door trolley 16, which is integral with the door leaf 1. The secondary rollers 15 are shown mounted on the support structure 16 but located lower than the rail 11. A belt drive 18 is provided to impart the drive to the door.

The adoption of the design of the header extrusion to include nut-running slots on the rear face provides a clear advantage of only having to machine features from one direction which results in a considerable cost saving in both time, effort and accuracy in not having to move a component weighing as much as 85-100 kg and 6.5 metres long part way through the machining process as well as enabling the inclusion of the features enabling the mounting of the track 11.

The track 11 can be an extrusion allowing for it to be attached to the header extrusion as a slot-in part thereby providing the running surface for the roller whilst also being supported by the header extrusion. One advantage of extruding the track is the provision of a consistent, smooth running surface profile with any imperfections in the surface being in the direction of travel of the roller. This reduces the likelihood of wear compared to the stainless steel J-track of the prior art solutions. Additionally the roller has two points of contact with the track and a larger diameter resulting in a more than halving of the wear rate and at least doubling the maintenance period required between replacement of the rollers.

The replacement of the roller during routine maintenance is also easier as it can be simply lifted off the track (once the door is supported) rather than having to be maneuvered along to the end of the J-track, and back, to be replaced.

1. A platform screen door system (1) having a fixed panel and a door panel (3), wherein the system is provided with a track (11) having a convex surface adapted to support a roller (14), which roller (14) is rotatably mounted on the moving panel and has a concave surface, wherein a secondary roller (15) is rotatably mounted on the door panel, which secondary roller (15) in the installed position is spaced from the track (11) and is adapted to hinder the door panel being lifted off of the track.

2. The platform screen door system according to claim 1, wherein the door panel is provided with a support structure (8), upon which support structure the roller (14) and secondary roller (15) are rotatably mounted.

3. The platform screen door system according to claim 1, wherein the roller (14) is profiled such that the roller has two points of contact (17) on the track.

4. The platform screen door system according to claim 1, wherein the track (11) has a C shaped profile in cross section with the open part of the C facing away from the header structure, the outer surface of the C shaped profile (11) providing the convex surface to support the roller.

5. The platform screen door system according to claim 4, wherein the rail is an extrusion.

6. (canceled)
